(19) United States
(12) Patent Application Publication
(10) Pub. No.: US 2026/0050235 A1
(43) Pub. Date: Feb. 19, 2026

(54) POST-PROCESSING APPARATUS AND IMAGE FORMING SYSTEM

(71) Applicant: FUJIFILM Business Innovation Corp., Tokyo (JP)

(72) Inventor: Shoya KINOSHITA, Kanagawa (JP)

(73) Assignee: FUJIFILM Business Innovation Corp., Tokyo (JP)

(21) Appl. No.: 19/056,873

(22) Filed: Feb. 19, 2025

(30) Foreign Application Priority Data
Aug. 16, 2024 (JP) 2024-137037

(51) Int. Cl. G03G 21/00; G03G 15/00

(52) U.S. Cl. CPC G03G 21/0052; G03G 15/6523

(57) ABSTRACT

A post-processing apparatus includes a cutter that cuts an edge of a transported recording medium, a collection container that is disposed below the cutter and that collects the edge when the edge cut by the cutter falls downward, and a blower that blows gas into the collection container.

### CROSS-REFERENCE TO RELATED APPLICATIONS

This application is based on and claims priority under 35 USC 119 from Japanese Patent Application No. 2024-137037 filed Aug. 16, 2024.

### BACKGROUND

### (i) Technical Field

The present disclosure relates to post-processing apparatuses and image forming systems.

### (ii) Related Art

An image forming apparatus according to Japanese Unexamined Patent Application Publication No. 2006-208823 includes an image forming unit that forms an image onto recording paper, a transport unit that transports the recording paper output from the image forming unit in close contact with a belt transport member, a cutting unit that cuts the recording paper transported by the transport unit, and a housing that supports the transport unit and the cutting unit together and that is positionally adjusted relative to the image forming unit.

### SUMMARY

A known post-processing device of the image forming apparatus has a function for cutting edges of sheet-like recording media. In such a post-processing device, the cut edges are dropped and collected into a collection box.

The edges collected in the collection box accumulate inside the collection box. However, the positions where the edges collected in the collection box are dropped are constantly similar positions. In other words, the positions where the edges collected in the collection box accumulate are uneven inside the collection box.

Aspects of non-limiting embodiments of the present disclosure relate to suppressing unevenness in the positions where the edges collected inside the collection box accumulate, as compared with a case where the cut edges of the recording media remain in a collected state inside the collection box and are not positionally changed inside the collection box.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a post-processing apparatus including a cutter that cuts an edge of a transported recording medium, a collection container that is disposed below the cutter and that collects the edge when the edge cut by the cutter falls downward, and a blower that blows gas into the collection container.

### BRIEF DESCRIPTION OF THE DRAWINGS

Exemplary embodiments of the present disclosure will be described in detail based on the following figures, wherein:

FIG. 1 schematically illustrates the configuration of an image forming system according to an exemplary embodiment of the present disclosure;

FIG. 2 is a side view illustrating a post-processing apparatus according to an exemplary embodiment of the present disclosure;

FIG. 3 is a plan view illustrating a cutter of the post-processing apparatus according to the exemplary embodiment of the present disclosure;

FIG. 4 is a plan view illustrating a collection box and a cooler of the post-processing apparatus according to the exemplary embodiment of the present disclosure;

FIG. 5 is a side view illustrating, for example, the collection box of the post-processing apparatus according to the exemplary embodiment of the present disclosure;

FIG. 6 is a front view illustrating, for example, the collection box of the post-processing apparatus according to the exemplary embodiment of the present disclosure;

FIG. 7 is a perspective view illustrating the cooler, the collection box, and a gloss fixer of the post-processing apparatus according to the exemplary embodiment of the present disclosure;

FIG. 8 is a side view illustrating the gloss fixer of the post-processing apparatus according to the exemplary embodiment of the present disclosure;

FIGS. 9A and 9B are block views illustrating the hardware configuration and the functional configuration of a controller of the post-processing apparatus according to the exemplary embodiment of the present disclosure; and

FIG. 10 is a perspective view illustrating a modification of the collection box of the post-processing apparatus according to the exemplary embodiment of the present disclosure.

### DETAILED DESCRIPTION

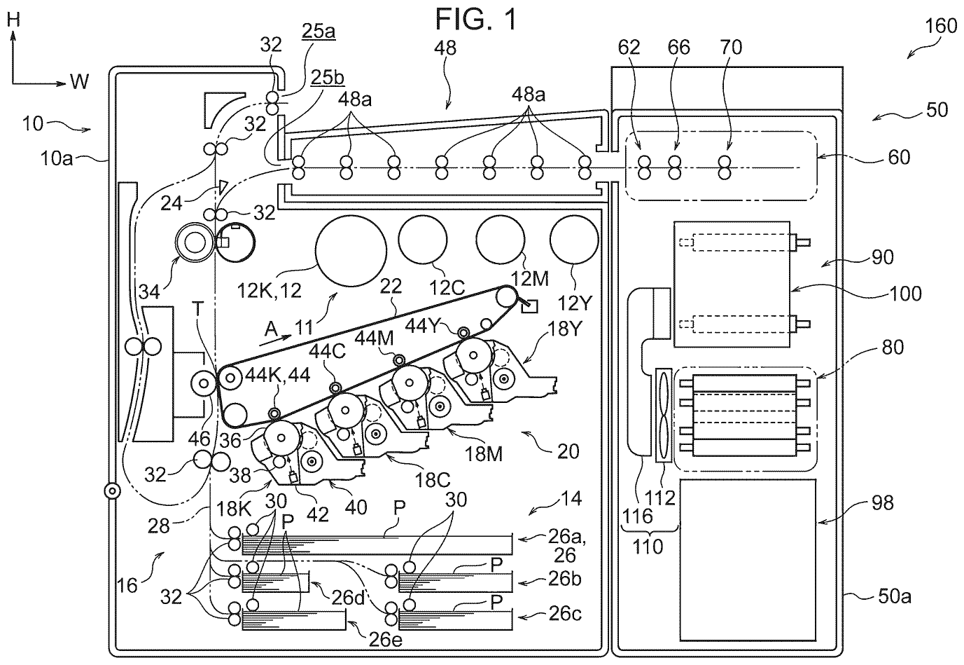

An example of a post-processing apparatus and an image forming system according to exemplary embodiments of the present disclosure will now be described with reference to FIGS. 1 to 10. An arrow H shown in each drawing denotes the vertical direction and indicates an up-down direction of the apparatus. An arrow W denotes the horizontal direction orthogonal to the arrow H, and indicates a width direction of the apparatus. An arrow D denotes the horizontal direction orthogonal to the arrow H and the arrow W, and indicates a depth direction of the apparatus.

### Overall Configuration of Image Forming System 160

As shown in FIG. 1, an image forming system 160 includes an image forming apparatus 10, a post-processing apparatus 50, and a relay transporter 48. The image forming apparatus 10 forms a toner image onto a recording medium P by electrophotography. The post-processing apparatus 50 removes edges Pe from the recording medium P having the toner image formed thereon by the image forming apparatus 10 and adds glossiness to the toner image. The post-processing apparatus 50 is for obtaining a margin-less photographic printed image. The relay transporter 48 transports the recording medium P having the image formed thereon by the image forming apparatus 10 toward the post-processing apparatus 50.

The relay transporter 48 is placed on an upper portion of the image forming apparatus 10. The image forming apparatus 10 and the post-processing apparatus 50 are arranged in this order from a first side toward a second side in the width direction. The width direction in this case refers to a left-right direction relative to a user in a state where the user is standing in front of the apparatus.

### Image Forming Apparatus 10

As shown in FIG. 1, the image forming apparatus 10 includes a medium container 14 and a transporter 16. The medium container 14 accommodates recording media P. The transporter 16 transports each recording medium P accommodated in the medium container 14. The image forming apparatus 10 further includes an image forming section 20 that performs image formation on the recording medium P transported from the medium container 14 by the transporter 16. The image forming apparatus 10 also includes a toner container 11 that contains toner. The medium container 14, the image forming section 20, and the toner container 11 are arranged in this order from the lower side toward the upper side.

### Medium Container 14

As shown in FIG. 1, the medium container 14 includes multiple container members 26 that are drawable forward in the depth direction from an apparatus body 10a of the image forming apparatus 10. The medium container 14 further includes feed rollers 30 that feed each of the recording media P stacked in the container members 26 toward a transport path 28. In this exemplary embodiment, there are five container members 26a to 26e provided. The container members 26d and 26e have photo paper stacked thereon for outputting photographs. The container members 26a to 26c have stacked thereon plain paper of standard size, such as A4 size or A3 size.

### Transporter 16

As shown in FIG. 1, the transporter 16 includes multiple transport rollers 32 that transport each of the recording media P fed from the container members 26 by the feed rollers 30 along the transport path 28. Moreover, the transporter 16 includes a sorting member 24 that sorts the recording media P discharged from the apparatus body 10a.

### Image Forming Section 20

As shown in FIG. 1, the image forming section 20 includes image forming units 18Y, 18M, 18C, and 18K as four forming units for yellow (Y), magenta (M), cyan (C), and black (K) colors. In the following description, Y, M, C, and K may sometimes be omitted if the Y, M, C, and K colors are not to be distinguished from one another.

The image forming unit 18 for each color includes an image bearing member 36, a charging member 38 that electrostatically charges the surface of the image bearing member 36, and an exposure device 42 that radiates exposure light onto the image bearing member 36. Furthermore, the image forming unit 18 for each color includes a developing device 40 that develops an electrostatic latent image formed as a result of the exposure device 42 radiating the exposure light onto the electrostatically-charged image bearing member 36.

The image forming section 20 includes an endless transfer belt 22 that revolves in the direction of an arrow A. Moreover, the image forming section 20 includes first-transfer rollers 44 that transfer toner images formed by the image forming units 18 for the respective colors onto the transfer belt 22. The image forming section 20 further includes a second-transfer roller 46 that transfers the toner images transferred on the transfer belt 22 onto the recording medium P. The image forming section 20 also includes a fixing device 34 that applies heat and pressure to the recording medium P having the toner images formed thereon so as to fix the toner images onto the recording medium P.

### Toner Container 11

As shown in FIG. 1, the toner container 11 includes a container member 12Y that contains yellow (Y) toner and a container member 12M that contains magenta (M) toner. The toner container 11 also includes a container member 12C that contains cyan (C) toner and a container member 12K that contains black (K) toner. The container members 12K, 12C, 12M, and 12Y are arranged in this order from the first (left) side toward the second (right) side in the width direction. The capacity of the container member 12K that contains the frequently-used black toner is larger than the capacities of the other container members 12.

### Operation of Image Forming Apparatus

In the image forming apparatus 10, an image is formed as follows.

First, the charging member 38 for each color to which voltage is applied electrostatically charges the surface of the corresponding image bearing member 36 uniformly to a predetermined negative potential. Then, based on image data input from the outside, the corresponding exposure device 42 forms an electrostatic latent image by radiating exposure light onto the electrostatically-charged surface of the corresponding image bearing member 36.

Accordingly, the electrostatic latent image corresponding to the image data is formed on the surface of the image bearing member 36. Furthermore, the corresponding developing device 40 develops this electrostatic latent image, whereby the image is visualized as a toner image. The corresponding first-transfer roller 44 transfers the toner image formed on the surface of the image bearing member 36 onto the transfer belt 22.

The recording medium P fed from any of the container members 26 to the transport path 28 by the corresponding feed roller 30 is fed to a transport position T where the transfer belt 22 and the second-transfer roller 46 are in contact with each other. At the transport position T, the recording medium P is transported between the transfer belt 22 and the second-transfer roller 46, whereby the toner image on the surface of the transfer belt 22 is transferred onto the recording medium P.

The toner image transferred on the recording medium P is fixed onto the recording medium P by the fixing device 34. Then, the recording medium P having the toner image fixed thereon is sorted by the sorting member 24. If the recording medium P is plain paper, the recording medium P is sorted by the sorting member 24 and is discharged outward of the apparatus body 10a from an outlet 25a. If the recording medium P is photo paper, the recording medium P is sorted by the sorting member 24 and is discharged from an outlet 25b located below the outlet 25a. Then, the recording medium P discharged from the outlet 25b is received by the relay transporter 48.

In order to prevent the toner from adhering to the second-transfer roller 46 when the toner image formed on the transfer belt 22 is fixed onto the recording medium P, the four edges of the recording medium P are provided with margin (void) edges Pe.

### Relay Transporter 48

The relay transporter 48 is attachable to and detachable from the apparatus body 10a of the image forming apparatus 10. As shown in FIG. 1, the relay transporter 48 receives the recording medium P discharged from the outlet 25b of the image forming apparatus 10 and transports the recording medium P to the post-processing apparatus 50.

In detail, the relay transporter 48 includes multiple transport rollers 48a. The multiple transport rollers 48a transport the recording medium P toward the post-processing apparatus 50.

### Post-Processing Apparatus 50

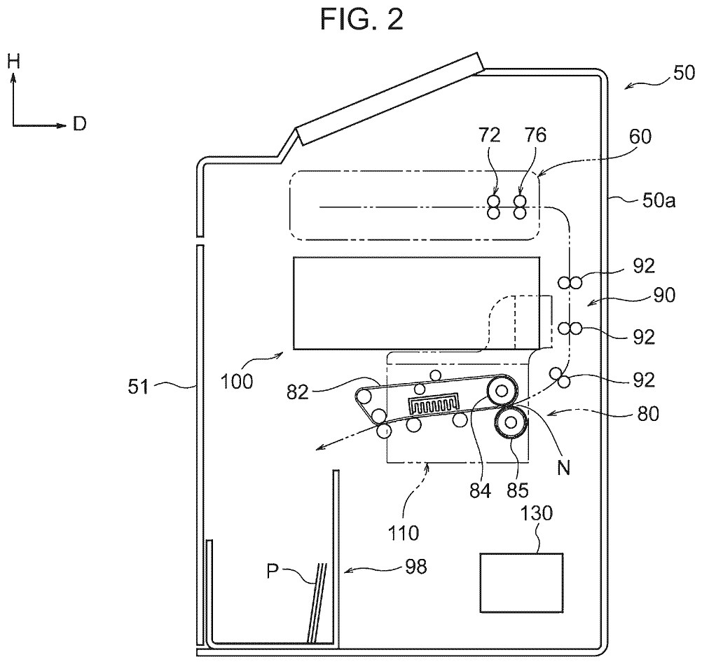

As shown in FIGS. 1 and 2, the post-processing apparatus 50 includes a cutter 60 that cuts and removes the four edges Pe from the recording medium P. Moreover, the post-processing apparatus 50 includes a gloss fixer 80 that adds glossiness to the toner image formed on the recording medium P, and also includes a cooler 110 that cools the gloss fixer 80.

Furthermore, the post-processing apparatus 50 includes a transporter 90 that transports the recording medium P. The post-processing apparatus 50 also includes a collection box 100 that collects the edges Pe cut by the cutter 60. The collection box 100 is an example of a collection container. Moreover, the post-processing apparatus 50 includes an output section 98 to which the recording medium P is output. The post-processing apparatus 50 includes a controller 130 that controls each unit. These units are provided inside an apparatus body 50a.

The cutter 60, the collection box 100, the gloss fixer 80, and the output section 98 are arranged in this order from the upper side toward the lower side in the up-down direction. Moreover, the collection box 100, the gloss fixer 80, and the cooler 110 are arranged in the width direction.

As shown in FIG. 2, the transporter 90 is disposed rearward of the cutter 60, the collection box 100, and the gloss fixer 80 in the depth direction. Furthermore, the output section 98 is disposed forward of the gloss fixer 80 in the depth direction. The term “depth direction” refers to the depth direction relative to the user in a state where the user is standing in front of the apparatus.

### Cutter 60

As shown in FIG. 1, the cutter 60 is disposed to receive, from the first widthwise side, the recording medium P having the toner image formed thereon and transported by the relay transporter 48.

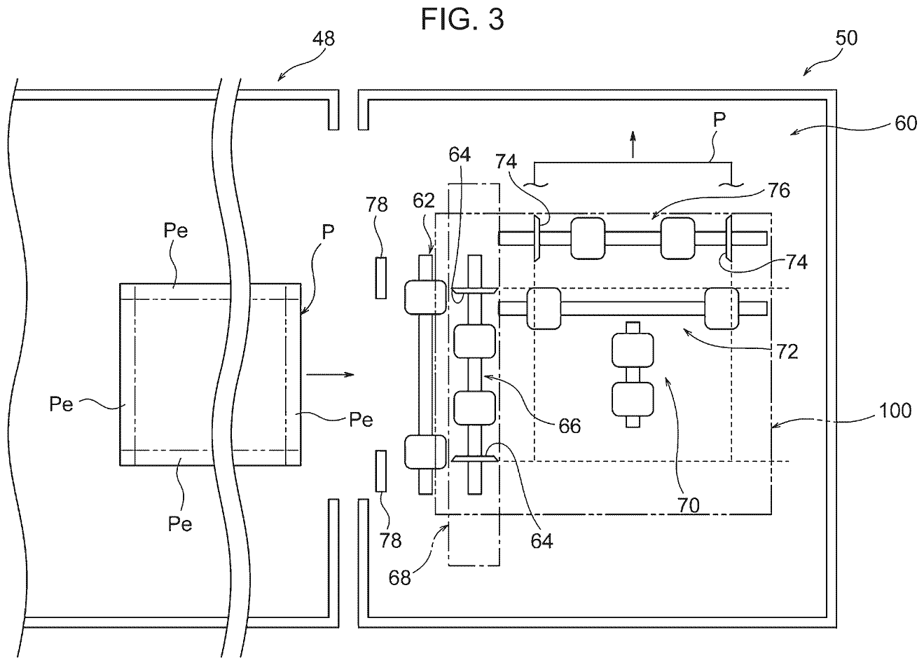

As shown in FIG. 3, the cutter 60 includes a transport roller 62 that receives the recording medium P transported in the width direction without changing the transport direction (referred to as “medium transport direction” hereinafter) of the recording medium P. The cutter 60 also includes a pair of first cutters 64 that cut the edges Pe of the recording medium P transported by the transport roller 62 while rotating. Moreover, the cutter 60 includes a transport roller 66 that has a shaft to which the first cutters 64 are attached and that applies a widthwise transport force to the recording medium P from which the edges Pe have been cut off.

The cutter 60 includes an adjustment mechanism 68 that causes the first cutters 64 and the transport roller 66 to be movable together in the axial direction to adjust the cutting position.

A transport roller 70 is disposed downstream of the adjustment mechanism 68 in the medium transport direction. The transport roller 70 transports the recording medium P, from which the edges Pe have been cut off by the first cutters 64, in the width direction to set the position of the recording medium P in the width direction. The transport roller 70 comes into contact with the recording medium P when transporting the recording medium P in the width direction, and moves away from the recording medium P when transporting the recording medium P toward the rear side in the depth direction.

The cutter 60 further includes a transport roller 72 for transporting the recording medium P toward the rear side in the depth direction. The cutter 60 also includes a pair of second cutters 74 that cut the edges Pe of the recording medium P transported toward the rear side in the depth direction by the transport roller 72 while rotating.

Moreover, the cutter 60 includes a transport roller 76 that has a shaft to which the second cutters 74 are attached and that applies a transport force in the depth direction to the recording medium P from which the edges Pe have been cut off. The transport roller 72 moves away from the recording medium P when transporting the recording medium P in the width direction, and comes into contact with the recording medium P when transporting the recording medium P toward the rear side in the depth direction.

With regard to the adjustment of the cutting position, a cutting-position detection sensor 78 disposed upstream of the transport roller 62 in the medium transport direction is configured to detect a cut end of a fixed image. Before the recording medium P enters a cutting mechanism, the cutting-position detection sensor 78 is disposed at an IN side (i.e., the front side of the apparatus) and an OUT side (i.e., the rear side of the apparatus) that enable differentiation between an image area and a non-image area.

In this configuration, the transport roller 62, the transport roller 66, and the transport roller 70 shown in FIG. 3 transport the recording medium P supplied from the image forming apparatus 10 via the relay transporter 48 from the first side toward the second side in the width direction. The first cutters 64 cut the edges Pe of the transported recording medium P, and the cut edges Pe are collected into the collection box 100.

The transport roller 72 and the transport roller 76 transport the recording medium P toward the rear side in the depth direction. The second cutters 74 cut the edges Pe of the transported recording medium P, and the cut edges Pe are collected into the collection box 100.

### Collection Box 100, Etc.

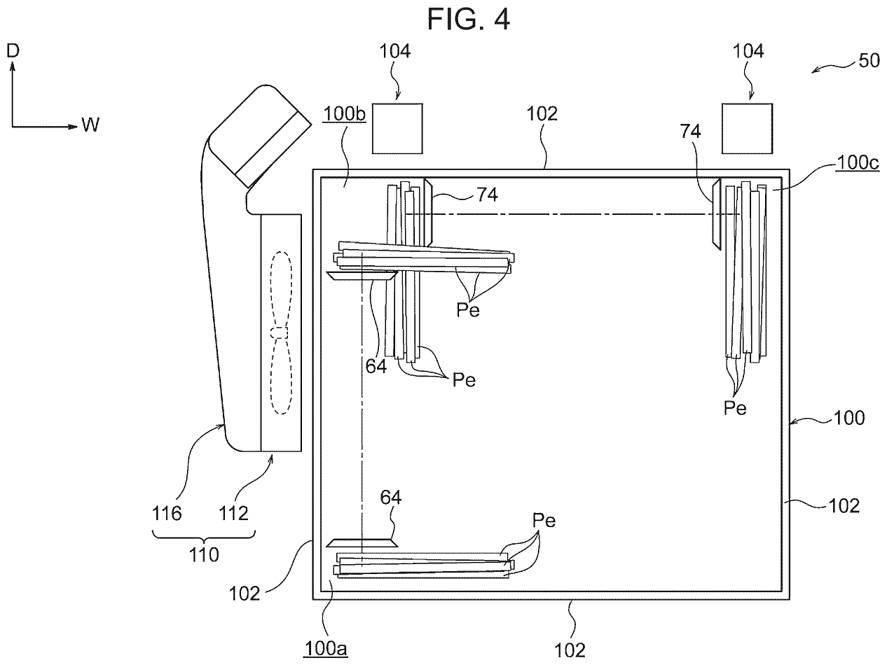

The collection box 100 has a shape of a box with an upper opening, and is disposed below the cutter 60 and above the gloss fixer 80, as shown in FIGS. 1 and 2. In detail, as shown in FIGS. 3 and 4, the collection box 100 is rectangular, as viewed from above.

In the post-processing apparatus 50, the apparatus body 50a is provided with a maintenance door 51 that exposes the interior of the post-processing apparatus 50 from the front side in the depth direction, as shown in FIG. 2. By exposing the interior of the apparatus body 50a through this maintenance door 51, the collection box 100 becomes attachable to and detachable from the apparatus body 50a from the front side in the depth direction.

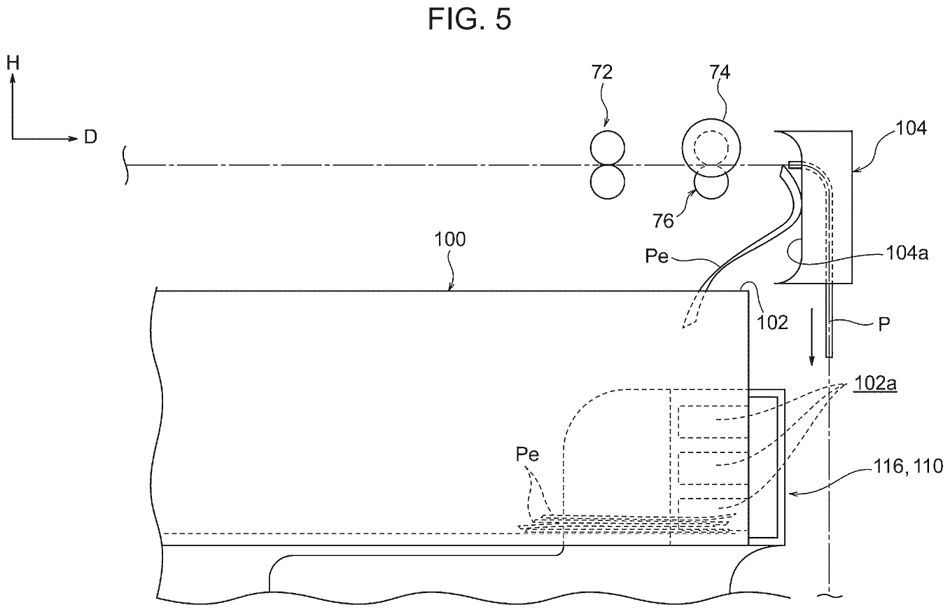

As shown in FIGS. 4 and 5, the post-processing apparatus 50 is provided with guides 104 that guide the edges Pe cut by the second cutters 74 toward the collection box 100. In detail, the guides 104 are provided as a pair and are respectively disposed rearward of the second cutters 74 in the depth direction and at the outer widthwise sides of the pair of second cutters 74. The term “outer widthwise sides” refer to the sides located away from the center of the recording medium P transported in the width direction.

As shown in FIG. 5, each guide 104 has a guide surface 104a facing the corresponding second cutter 74. Each edge Pe cut by the corresponding second cutter 74 is folded back by coming into contact with the corresponding guide surface 104a, so that the edge Pe is collected into the collection box 100.

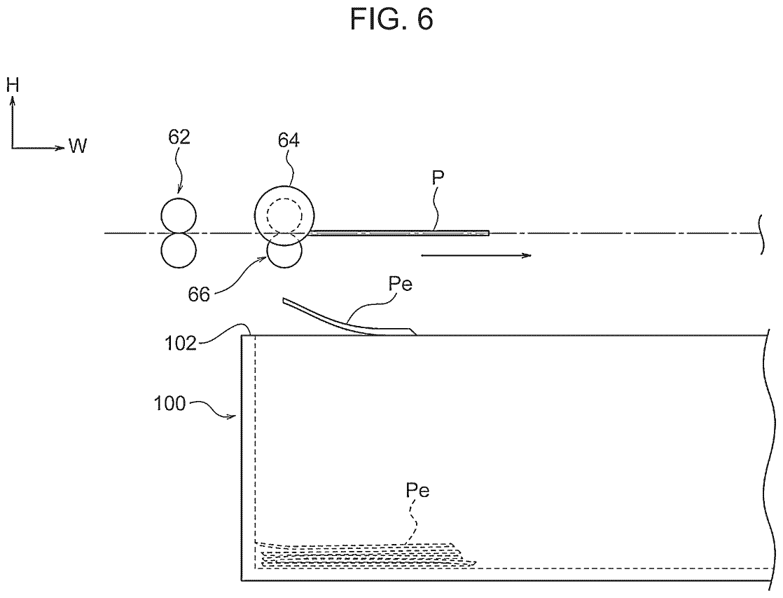

On the other hand, each of the edges Pe cut by the first cutters 64 falls downward directly so as to be collected into the collection box 100, as shown in FIG. 6.

In this configuration, as shown in FIG. 4, the edges Pe cut by the first cutter 64 at the front side in the depth direction are collected and stacked at a corner 100a located at the front side in the depth direction of the collection box 100 and at the first widthwise side thereof. The edges Pe cut by the first cutter 64 at the rear side in the depth direction are collected and stacked at a corner 100b located at the rear side in the depth direction of the collection box 100 and at the first widthwise side.

The edges Pe cut by the second cutter 74 at the first widthwise side are collected and stacked at the corner 100a of the collection box 100. The edges Pe cut by the second cutter 74 at the second widthwise side are collected and stacked at a corner 100c located at the rear side in the depth direction of the collection box 100 and at the second widthwise side.

Accordingly, the edges Pe cut by the first cutters 64 are collected and stacked at the corners 100a and 100b of the collection box 100. On the other hand, the edges Pe cut by the second cutters 74 are collected and stacked at the corners 100b and 100c of the collection box 100. Consequently, the number of edges Pe collected at the corner 100b of the collection box 100 is greater than the number of edges Pe collected at the corners 100a and 100c.

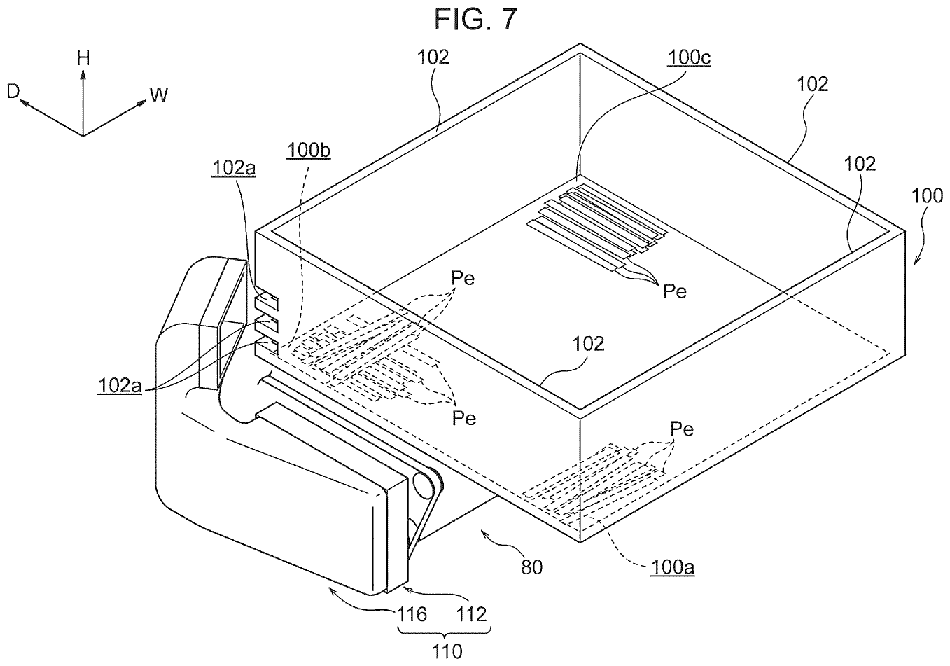

As shown in FIG. 7, side plates 102 constituting the corner 100b of the collection box 100 have through-holes 102a arranged in the up-down direction. In detail, multiple through-holes 102a are arranged in the up-down direction in a butted section of a pair of butted side plates 102 and in a lower area of the side plates 102. The side plates 102 are an example of a side part.

### Transporter 90

As shown in FIG. 2, the transporter 90 is disposed rearward of the collection box 100 in the depth direction. The transporter 90 includes multiple transport rollers 92 that receive the recording medium P delivered by the cutter 60 and that transport the recording medium P toward the gloss fixer 80. The axial direction of each of the multiple transport rollers 92 is set as the width direction.

### Gloss Fixer 80

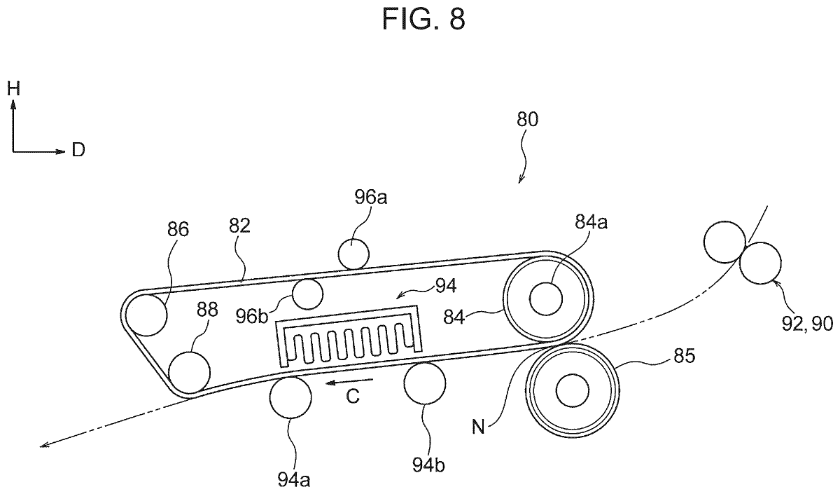

As shown in FIG. 8, the gloss fixer 80 includes an endless fixing belt 82, a heating roller 84, a release roller 88, and a control roller 86 that controls a workpiece. The fixing belt 82 is wound around the heating roller 84, the release roller 88, and the control roller 86. The heating roller 84 rotatably supports the fixing belt 82 and has a hollow portion therein that is provided with a halogen lamp 84a that heats a fixed region of a nip N. The gloss fixer 80 is an example of a heater.

The gloss fixer 80 further includes a pressure roller 85 that forms the nip N by coming into pressure contact with the heating roller 84 with the fixing belt 82 interposed therebetween. The heating roller 84 is rotationally driven by a drive source (not shown), whereby the fixing belt 82 revolves in the direction of an arrow C.

A heatsink 94 that forcibly cools the recording medium P that is in close contact with the fixing belt 82 is provided within the fixing belt 82. The heatsink 94 is cooled by a cooling fan 112 (see FIG. 7). In order to assist with the close contact between the transported recording medium P and the fixing belt 82, biasing rollers 94a and 94b that bias the recording medium P toward the fixing belt 82 are disposed at positions facing the heatsink 94 with the fixing belt 82 interposed therebetween. Small-diameter tension rollers 96a and 96b that apply fixed tension to the fixing belt 82 are disposed between the control roller 86 and the heating roller 84.

In this configuration, the recording medium P transported by the transporter 90 enters the nip N. Then, the toner image formed on the recording medium P becomes embedded in an image-receiving layer of the recording medium P by heat and pressure. Accordingly, glossiness occurs in the toner image on the surface of the recording medium P.

### Cooler 110

As shown in FIG. 1, the cooler 110 is disposed at the first widthwise side relative to the collection box 100 and the gloss fixer 80. The cooler 110 includes the cooling fan 112 and a duct 116. The cooler 110 is an example of a blower, and the cooling fan 112 is an example of a suction fan.

The cooling fan 112 is a so-called suction fan disposed at the first widthwise side of the gloss fixer 80, as shown in FIG. 7. The cooling fan 112 suctions air heated by the gloss fixer 80, so as to cool the gloss fixer 80. In detail, the cooling fan 112 suctions the air heated by the gloss fixer 80, so as to cool the heatsink 94 (see FIG. 8) of the gloss fixer 80. The air is an example of gas.

As shown in FIG. 7, the duct 116 is disposed astride the gloss fixer 80 and the collection box 100 in the up-down direction. In detail, an opening at one end of the duct 116 is oriented toward the cooling fan 112, whereas an opening at the other end of the duct 116 is oriented toward the corner 100b of the collection box 100.

In this configuration, the air suctioned by the cooling fan 112 flows through the duct 116 and is discharged toward the corner 100b of the collection box 100. Moreover, the air discharged toward the corner 100b is blown into the collection box 100 via the through-holes 102a. In other words, the cooler 110 blows air into the collection box 100.

### Output Section 98

As shown in FIG. 1, the output section 98 is disposed below the gloss fixer 80. Furthermore, as shown in FIG. 2, the output section 98 is disposed forward of the gloss fixer 80 in the depth direction.

When the interior of the apparatus body 50a is exposed through the maintenance door 51, the recording medium P output to the output section 98 is retrievable from the apparatus body 50a.

### Controller 130

The controller 130 controls the cooling fan 112 based on, for example, an operation signal of the gloss fixer 80. In detail, the controller 130 causes the cooling fan 112 to operate while the gloss fixer 80 is in operation. Moreover, the controller 130 changes the wind pressure of the air blown into the collection box 100 by the cooling fan 112 for every predetermined time period. The controller 130 is an example of a processor.

### Hardware Configuration of Controller 130

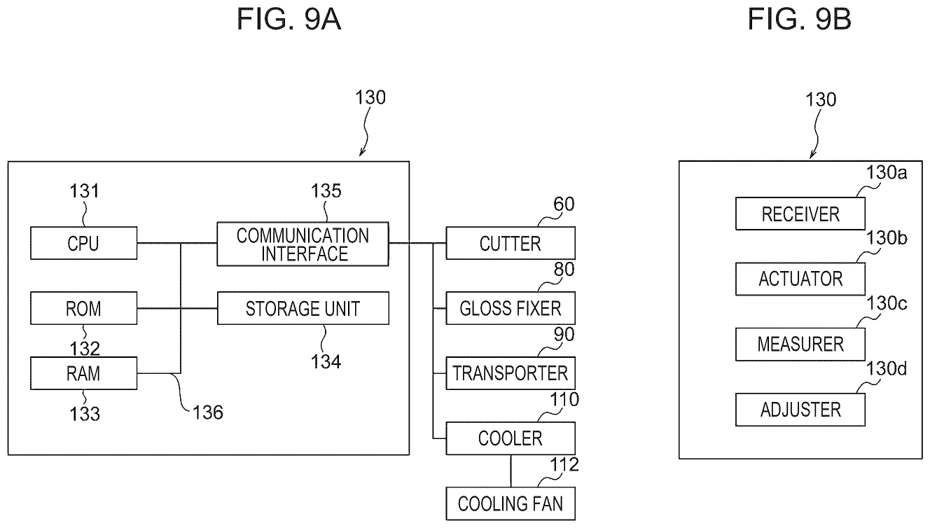

As shown in FIG. 9A, the controller 130 includes a central processing unit (CPU) 131, a read-only memory (ROM) 132, a random access memory (RAM) 133, a storage unit 134, and a communication interface 135. These components are connected to one another in a communicable manner by a bus 136.

The CPU 131 is a central processing unit that executes various types of programs and that controls each unit. Specifically, the CPU 131 loads a program from the ROM 132 or the storage unit 134 and executes the program by using the RAM 133 as a work area. The CPU 131 controls each component and performs various types of arithmetic processing in accordance with the program stored in the ROM 132 or the storage unit 134.

In this exemplary embodiment, for example, the ROM 132 or the storage unit 134 has stored therein a control program that controls the wind pressure from the cooling fan 112 based on an operation time of the gloss fixer 80.

The RAM 133 serves as a work area that temporarily stores a program or data. The storage unit 134 is a hard disk drive (HDD) or a solid state drive (SSD), and has stored therein various types of programs, including an operating system, and various types of data.

The communication interface 135 is an interface used by the controller 130 for communicating with, for example, the cutter 60, the gloss fixer 80, the transporter 90, and the cooler 110, and uses a standard such as Ethernet (registered trademark), fiber distributed data interface (FDDI), or Wi-Fi (registered trademark).

When the operation program described above is to be executed, the controller 130 implements various types of functions by using the hardware resources mentioned above. A functional configuration of the controller 130 for causing the controller 130 to implement the various types of functions will now be described.

### Function Configuration of Controller 130

As shown in FIG. 9B, the controller 130 includes a receiver 130a, an actuator 130b, a measurer 130c, and an adjuster 130d. Each of these functional units is implemented as a result of the CPU 131 loading the control program stored in the ROM 132 or the storage unit 134 and executing the control program. The control of each unit by the controller 130 will be described below together with the operation.

### Operation

Next, the operation of the post-processing apparatus 50 will be described. Steps to be performed by the post-processing apparatus 50 are executed as a result of the controller 130 controlling the respective units.

When the receiver 130a of the controller 130 receives a command for adding glossiness to the surface of the recording medium P, the controller 130 actuates each unit. In detail, the actuator 130b of the controller 130 actuates the cutter 60, the transporter 90, the gloss fixer 80, and the cooler 110.

Then, the recording medium P supplied from the image forming apparatus 10 via the relay transporter 48 shown in FIG. 1 is transported in the width direction by the transport roller 62. In detail, a sensor (not shown) or the like detects that the leading end of the recording medium P has reached near, for example, the transport roller 62. Then, the transport roller 70 shown in FIG. 3 is set in a contact state with the recording medium P, whereas the transport roller 72 is set in a separated state from the recording medium P.

The transport roller 62, the transport roller 66, the transport roller 70, and the first cutters 64 rotate, so that the recording medium P is transported in the width direction. The edges Pe of the recording medium P passing through the first cutters 64 are cut by the first cutters 64.

As shown in FIGS. 4 and 6, the cut edges Pe are dropped and collected into the collection box 100 (see FIG. 2). In detail, the edges Pe cut by the first cutters 64 are dropped and collected at the corners 100a and 100b of the collection box 100.

After the edges Pe are cut by the first cutters 64, the transport of the recording medium P is temporarily stopped at a predetermined position in the cutter 60. Then, in the cutter 60 shown in FIG. 3, the transport roller 70 is set in a separated state from the recording medium P, whereas the transport roller 72 is set in a contact state with the recording medium P. Moreover, the transport roller 72, the transport roller 76, and the second cutters 74 rotate to transport the recording medium P toward the rear side in the depth direction.

The edges Pe of the recording medium P passing through the second cutters 74 are cut by the second cutters 74. The cut edges Pe are collected into the collection box 100. In detail, as shown in FIG. 5, the edges Pe cut by the second cutters 74 are folded back by coming into contact with the guide surfaces 104a of the guides 104. Accordingly, as shown in FIG. 4, the edges Pe are collected at the corners 100b and 100c of the collection box 100. At the corner 100b, the edges Pe cut by the first cutters 64 are also collected.

Accordingly, the cut edges Pe are collected at the corners 100a, 100b, and 100c of the collection box 100. In other words, the positions where the edges Pe collected inside the collection box 100 accumulate are uneven. Moreover, the number of edges Pe collected at the corner 100b of the collection box 100 is greater than the number of edges Pe collected at each of the corners 100a and 100c.

After the edges Pe are cut by the second cutters 74, the transporter 90 shown in FIG. 2 transports the recording medium P and causes the recording medium P to enter the nip N.

At the nip N shown in FIG. 8, the heat from the halogen lamp 84a and the pressure from the pressure roller 85 cause the toner constituting the toner image to become fused by being heated to substantially about 120° C. to 150° C. Then, the toner image becomes embedded in the image-receiving layer of the thermally-softened recording medium P. Subsequently, after passing through the nip N, the recording medium P is transported in a close contact state with the fixing belt 82. During this transport, the recording medium P is forcibly cooled by the heatsink 94, and the smoothness of the surface of the fixing belt 82 is transferred onto the surface of the recording medium P, that is, the image-receiving layer, whereby glossiness occurs in the toner image on the surface of the recording medium P.

Furthermore, the transported recording medium P is cooled to a temperature lower than or equal to a toner fusing temperature (e.g., about 40° C. to 80° C.) near the release roller 88. Then, due to the stiffness of the recording medium P having reached the release roller 88, the recording medium P is released from the fixing belt 82. The recording medium P released from the fixing belt 82 is output to the output section 98 shown in FIG. 2.

The control of the cooler 110 by the controller 130 and the edges Pe collected by the collection box 100 will now be described.

As mentioned above, when the receiver 130a of the controller 130 receives a command for adding glossiness to the surface of the recording medium P, the actuator 130b of the controller 130 actuates each unit. Accordingly, the gloss fixer 80 and the cooler 110 shown in FIG. 7 are actuated. Actuating the gloss fixer 80 causes the air surrounding the gloss fixer 80 to become heated. On the other hand, actuating the cooler 110 causes the cooling fan 112 to suction the air heated by the gloss fixer 80. Accordingly, the gloss fixer 80 is cooled. In detail, the cooling fan 112 suctions the air heated by the gloss fixer 80, whereby the heatsink 94 (see FIG. 8) of the gloss fixer 80 is cooled.

The measurer 130c of the controller 130 measures time from the start of actuation of the gloss fixer 80. Moreover, the adjuster 130d of the controller 130 receives the measured time from the measurer 130c and changes the air suction force from the cooling fan 112. In detail, the adjuster 130d of the controller 130 receives the measured time from the measurer 130c. Then, the adjuster 130d increases the air suction force from the cooling fan 112 for every predetermined time period (in a periodical manner). For example, every time a recording medium P enters the gloss fixer 80, the adjuster 130d increases the suction force by a factor of two or more, as compared with the normal suction force prior to the entry of the recording medium P into the gloss fixer 80. When the recording medium P is output from the gloss fixer 80, the adjuster 130d sets the suction force for the recording medium P back to the normal suction force.

On the other hand, the air suctioned by the cooling fan 112 flows through the duct 116, is discharged toward the corner 100b of the collection box 100, and is blown into the collection box 100 via the through-holes 102a. In other words, the cooler 110 blows the air into the collection box 100.

The air blown into the collection box 100 causes the edges Pe collected and accumulated at the corners 100a, 100b, and 100c of the collection box 100 to fly inside the collection box 100. In other words, the air suction force from the cooling fan 112 is periodically increased by the adjuster 130d of the controller 130. Accordingly, the wind pressure of the air blown into the collection box 100 is periodically increased. Then, the manner in which the edges Pe fly changes periodically.

### CONCLUSION

As described above, in the post-processing apparatus 50, the cooler 110 blows air into the collection box 100. Then, the edges Pe collected and accumulated in the collection box 100 fly inside the collection box 100.

In the post-processing apparatus 50, the adjuster 130d of the controller 130 changes the air suction force from the cooling fan 112. In other words, the adjuster 130d of the controller 130 changes the wind pressure of the air blown into the collection box 100 by the cooler 110.

In the post-processing apparatus 50, the adjuster 130d of the controller 130 periodically increases the air suction force from the cooling fan 112. In other words, the adjuster 130d of the controller 130 periodically increases the wind pressure of the air blown into the collection box 100 by the cooler 110.

In the post-processing apparatus 50, the cooler 110 blows air into the collection box 100 via the through-holes 102a in the side plates 102.

In the post-processing apparatus 50, the through-holes 102a are provided in a lower area of the side plates 102.

In the post-processing apparatus 50, the cutter 60 cuts the edges Pe of the recording medium P having the toner image formed thereon. Accordingly, the edges Pe collected and accumulated in the collection box 100 fly inside the collection box 100.

In the post-processing apparatus 50, the cooler 110 includes the cooling fan 112 and the duct 116 that guides the air suctioned by the cooling fan 112 into the collection box 100.

In the post-processing apparatus 50, the gloss fixer 80 is disposed below the collection box 100. Moreover, the heated air rises.

The image forming system 160 is equipped with the post-processing apparatus 50 having the cooler 110 that blows air into the collection box 100.

Although a specific exemplary embodiment of the present disclosure has been described above, the exemplary embodiment of the present disclosure is not limited thereto. It is obvious to a skilled person that other various exemplary embodiments are possible within the scope of the present disclosure. For example, as an alternative to the above exemplary embodiment in which air is blown into the collection box 100, any gas may be used. For example, the gas may be nitrogen.

In the above exemplary embodiment, the adjuster 130d of the controller 130 changes the wind pressure of the air blown into the collection box 100 by the cooler 110. For example, the wind pressure may be repeatedly increased and decreased at fixed intervals. The adjuster may change the wind pressure of the air in accordance with a command from the outside.

In the above exemplary embodiment, the adjuster 130d of the controller 130 periodically increases the wind pressure of the air blown into the collection box 100 by the cooler 110. Alternatively, the wind pressure of the air blown into the collection box may be increased irregularly. In this case, an effect exhibited by periodically increasing the wind pressure is not exhibited.

In the above exemplary embodiment, the cooler 110 blows air into the collection box 100 via the through-holes 102a in the side plates 102. Alternatively, the cooler may blow the air into the collection box through the upper opening of the collection box. In this case, an effect exhibited by blowing the air into the collection box 100 via the through-holes 102a of the side plates 102 is not exhibited.

In the above exemplary embodiment, the cooler 110 blows air into the collection box 100 via the through-holes 102a in the side plates 102. Alternatively, the cooler may blow the air into the collection box through multiple locations.

In the above exemplary embodiment, the through-holes 102a are provided in a lower area of the side plates 102. Alternatively, the through-holes may be provided in an upper area of the side plates. In this case, an effect exhibited by providing the through-holes 102a in the lower area of the side plates 102 is not exhibited.

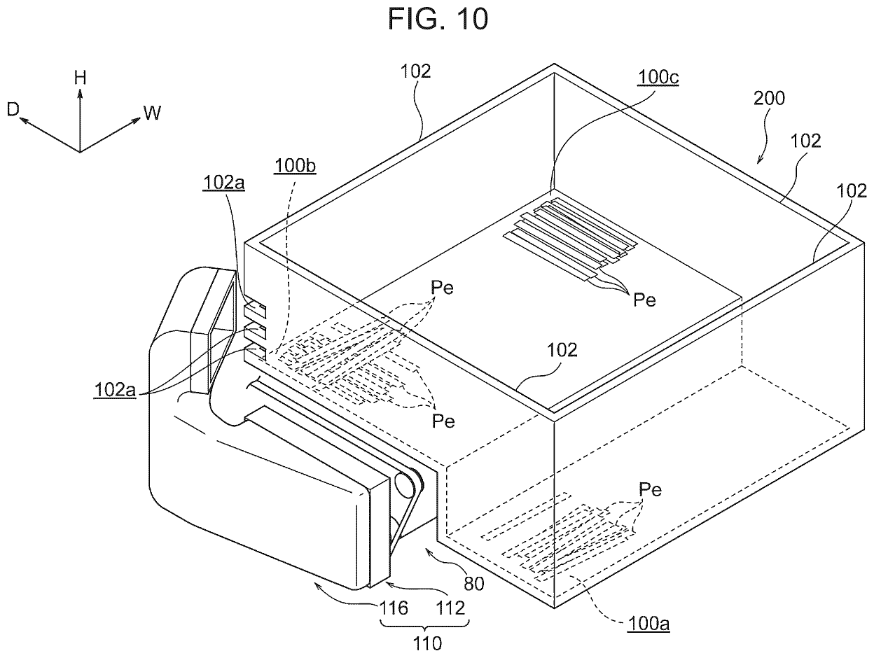

Although not specifically described in the above exemplary embodiment, a front area of a collection box 200 in the depth direction may have a depth greater than the depth of other areas, as shown in FIG. 10, so long as the collection box 200 does not interfere with the gloss fixer 80.

Although not specifically described in the above exemplary embodiment, the image forming system 160 may be constituted of a single apparatus or multiple apparatuses.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1))) A post-processing apparatus comprising:
a cutter that cuts an edge of a transported recording medium;
a collection container that is disposed below the cutter and that collects the edge when the edge cut by the cutter falls downward; and
a blower that blows gas into the collection container.

(((2))) The post-processing apparatus according to (((1))), further comprising:
at least one processor configured to:
   change a wind pressure of the gas blown by the blower.

(((3))) The post-processing apparatus according to (((2))),
wherein the processor is configured to periodically increase the wind pressure of the gas blown by the blower.

(((4))) The post-processing apparatus according to any one of (((1))) to (((3))),
wherein a side part of the collection container is provided with a through-hole, and
wherein the blower blows the gas into the collection container via the through-hole.

(((5))) The post-processing apparatus according to (((4))),
wherein the through-hole is provided in a lower area of the side part.

(((6))) The post-processing apparatus according to any one of (((1))) to (((5))),
wherein the cutter cuts the edge of the recording medium having a toner image formed thereon.

(((7))) The post-processing apparatus according to (((6))), further comprising:
a heater that heats the toner image formed on the recording medium from which the edge is cut,
wherein the blower includes a suction fan that suctions gas surrounding the heater and a duct that guides the gas suctioned by the suction fan into the collection container.

(((8))) The post-processing apparatus according to (((7))),
wherein the heater is disposed below the collection container.

(((9))) An image forming system comprising:
an image forming apparatus that forms an image onto a recording medium;
a relay transporter that transports the recording medium having the image formed thereon by the image forming apparatus; and
the post-processing apparatus according to any one of (((1))) to (((8))) that cuts the edge of the recording medium transported by the relay transporter.

What is claimed is:

1. A post-processing apparatus comprising:
a cutter that cuts an edge of a transported recording medium;
a collection container that is disposed below the cutter and that collects the edge when the edge cut by the cutter falls downward; and
a blower that blows gas into the collection container.

2. The post-processing apparatus according to claim 1, further comprising:
at least one processor configured to:
change a wind pressure of the gas blown by the blower.

3. The post-processing apparatus according to claim 2,
wherein the processor is configured to periodically increase the wind pressure of the gas blown by the blower.

4. The post-processing apparatus according to claim 1,
wherein a side part of the collection container is provided with a through-hole, and
wherein the blower blows the gas into the collection container via the through-hole.

5. The post-processing apparatus according to claim 4,
wherein the through-hole is provided in a lower area of the side part.

6. The post-processing apparatus according to claim 1,
wherein the cutter cuts the edge of the recording medium having a toner image formed thereon.

7. The post-processing apparatus according to claim 6, further comprising:
a heater that heats the toner image formed on the recording medium from which the edge is cut,
wherein the blower includes a suction fan that suctions gas surrounding the heater and a duct that guides the gas suctioned by the suction fan into the collection container.

8. The post-processing apparatus according to claim 7,
wherein the heater is disposed below the collection container.

9. An image forming system comprising:
an image forming apparatus that forms an image onto a recording medium;
a relay transporter that transports the recording medium having the image formed thereon by the image forming apparatus; and
the post-processing apparatus according to claim 1 that cuts the edge of the recording medium transported by the relay transporter.

10. An image forming system comprising:
an image forming apparatus that forms an image onto a recording medium;
a relay transporter that transports the recording medium having the image formed thereon by the image forming apparatus; and
the post-processing apparatus according to claim 2 that cuts the edge of the recording medium transported by the relay transporter.

11. An image forming system comprising:
an image forming apparatus that forms an image onto a recording medium;
a relay transporter that transports the recording medium having the image formed thereon by the image forming apparatus; and
the post-processing apparatus according to claim 3 that cuts the edge of the recording medium transported by the relay transporter.

12. An image forming system comprising:
an image forming apparatus that forms an image onto a recording medium;
a relay transporter that transports the recording medium having the image formed thereon by the image forming apparatus; and
the post-processing apparatus according to claim 4 that cuts the edge of the recording medium transported by the relay transporter.

13. An image forming system comprising:
an image forming apparatus that forms an image onto a recording medium;
a relay transporter that transports the recording medium having the image formed thereon by the image forming apparatus; and
the post-processing apparatus according to claim 5 that cuts the edge of the recording medium transported by the relay transporter.

14. An image forming system comprising:
an image forming apparatus that forms an image onto a recording medium;
a relay transporter that transports the recording medium having the image formed thereon by the image forming apparatus; and
the post-processing apparatus according to claim 6 that cuts the edge of the recording medium transported by the relay transporter.

15. An image forming system comprising:
an image forming apparatus that forms an image onto a recording medium;
a relay transporter that transports the recording medium having the image formed thereon by the image forming apparatus; and
the post-processing apparatus according to claim 7 that cuts the edge of the recording medium transported by the relay transporter.

16. An image forming system comprising:
an image forming apparatus that forms an image onto a recording medium;
a relay transporter that transports the recording medium having the image formed thereon by the image forming apparatus; and
the post-processing apparatus according to claim 8 that cuts the edge of the recording medium transported by the relay transporter.

17. A post-processing apparatus comprising:
cutting means for cutting an edge of a transported recording medium;
collecting means for collecting the edge when the edge cut by the cutting means falls downward, the collecting means being disposed below the cutting means; and
blowing means for blowing gas into the collecting means.
